(19) United States
(12) Patent Application Publication
(10) Pub. No.: US 2024/0202705 A1
(43) Pub. Date: Jun. 20, 2024

(54) METHOD FOR PROVIDING VIRTUAL KEYBOARD SERVICE THAT PAYS CRYPTOCURRENCY REWARDS USING USER WALLET PROVIDED BY SERVICE PROVIDER AND APPARATUS USING THE SAME

(71) Applicant: SK Planet Co., Ltd., Seongnam-si, Gyeonggi-do (KR)

(72) Inventors: Chang-Young KIM, Seongnam-si, Gyeonggi-do (KR); Ho-Jung RYU, Seongnam-si, Gyeonggi-do (KR)

(21) Appl. No.: 18/359,885

(22) Filed: Jul. 27, 2023

(30) Foreign Application Priority Data
Dec. 20, 2022 (KR) 10-2022-0179334

(51) Int. Cl. G06Q 20/36; G06Q 20/12; G06Q 20/38; G06Q 30/0207

(52) U.S. Cl. CPC G06Q 20/3672; G06Q 20/127; G06Q 20/3678; G06Q 20/3829; G06Q 20/389; G06Q 30/0215

(57) ABSTRACT

Disclosed herein are a method for providing a virtual keyboard service that pays cryptocurrency rewards using a user wallet provided by a service provider and an apparatus using the same. The method and apparatus may create an on-chain user wallet and an off-chain-based virtual blockchain user wallet which match each other and lend the created user wallets to a user who uses the virtual keyboard service, provide cryptocurrency that is mined while the user uses the virtual keyboard service to the virtual blockchain user wallet, and provide an on-chain service to the user by linking the on-chain user wallet with the virtual blockchain user wallet at preset link timing.

### CROSS REFERENCE TO RELATED APPLICATION

This application claims priority to Republic of Korea Patent Application No. 10-2022-0179334, filed Dec. 20, 2022, which is hereby incorporated by reference in its entirety.

### BACKGROUND OF THE INVENTION

### Technical Field

The present disclosure relates generally to technology for providing a virtual keyboard service that pays cryptocurrency rewords using a user wallet provided by a service provider, and more particularly to technology for allowing a service provider to create on-chain user wallets and off-chain-based virtual blockchain user wallets and lend the created user wallets to users who use the virtual keyboard service, thus allowing the users to use an on-chain service without requiring separate on-chain access.

### Description of the Related Art

Recently, with the increasing interest in Non-Fungible Tokens (NFTs), numerous X to Earn (X2E) projects incorporating blockchain technology have been launched, wherein X2E refers to the concept of giving rewards for specific actions.

For example, there is a service for allowing a user to earn money by playing game as in the case of Play to Earn (P2E) or Move to Earn (M2E) or by mining coins while walking or running.

Such a service is literally provided to users in the form of methods such as cashing out virtual assets rewarded through game play or a method of purchasing NFTs and cashing out virtual asset rewards by earning virtual asset rewards based on the fluctuating value of the NFTs.

### SUMMARY OF THE INVENTION

Accordingly, the present disclosure has been made keeping in mind the above problems occurring in the prior art, and an object of the present disclosure is to maximize user convenience by allowing a user who uses a virtual keyboard service to exploit a virtual blockchain user wallet in an off-chain without requiring on-chain interaction inconvenient to the user.

Another object of the present disclosure is to provide convenience to users who use a virtual keyboard service by allowing a service provider to act as an intermediary in service tasks for securely storing and exchanging cryptocurrency assets of the users.

A further object of the present disclosure is to provide a service for earning money through communication between users, such as Communication-to-Earn (C2E), thus inducing active communication between family members, friends, or acquaintances and providing benefits based on the active communication.

Yet another object of the present disclosure is to provide related rewards to users who hold word NFTs by converting words, which are chiefly used when a virtual keyboard service is provided, into NFTs and providing the NFTs.

Still another object of the present disclosure is to provide a virtual keyboard service in which a blockchain technology is introduced to a virtual keyboard used by a user terminal, thus providing differentiated customer benefits and experiences compared to a conventional point provision-based virtual keyboard service.

Still another object of the present disclosure is to provide more diverse benefits depending on the usage or usage amount of a virtual keyboard, without being limited to the service of simply utilizing a terminal-based virtual keyboard used by multiple users.

Still another object of the present disclosure is to design the structure of a virtual keyboard service for paying cryptocurrency rewards to be switchable to a point-accumulative virtual keyboard service, thus effectively securing multiple customers.

In accordance with an aspect of the present disclosure to accomplish the above objects, there is provided a method for providing a virtual keyboard service, including creating an on-chain user wallet and an off-chain-based virtual blockchain user wallet which match each other, and lending the created user wallets to a user who uses the virtual keyboard service, providing cryptocurrency that is mined while the user uses the virtual keyboard service to the virtual blockchain user wallet, and providing an on-chain service to the user by linking the on-chain user wallet with the virtual blockchain user wallet at preset link timing.

The method may further include charging a lending fee for the on-chain user wallet and the virtual blockchain user wallet to the user at intervals of a preset period.

An off-chain address at which the virtual blockchain user wallet is created may be identical to an on-chain address at which the on-chain user wallet is created.

The user may use the on-chain service based on the virtual blockchain user wallet without requiring on-chain interaction.

The user may access the virtual blockchain user wallet using both a public key provided from a service provider of the virtual keyboard service and a private key for user authentication, and may then use the on-chain service.

The service provider may store pubic keys and private keys for respective users required for accessing corresponding on-chain user wallets.

The cryptocurrency may correspond to a first token that is a keyboard token usable in the virtual keyboard service, and the first token may be exchangeable with a second token that is a governance token capable of being encashed in a cryptocurrency exchange.

The virtual keyboard service may be configured to mine cryptocurrency in conformity with keyboard usage that is measured while the user accesses an application based on a keyboard Non-Fungible Token (NFT) and uses a virtual keyboard, and to provide a reward corresponding to the mined cryptocurrency to the virtual blockchain user wallet of the user.

The virtual keyboard service may be configured to mine the cryptocurrency in conformity with usage of each word corresponding to a word NFT purchased by the user, and to provide a reward corresponding to the mined cryptocurrency to the virtual blockchain user wallet of the user.

In accordance with another aspect of the present disclosure to accomplish the above objects, there is provided an apparatus for providing a virtual keyboard service, including a processor configured to create an on-chain user wallet and an off-chain-based virtual blockchain user wallet which match each other, lend the created user wallets to a user who uses the virtual keyboard service, provide cryptocurrency that is mined while the user uses the virtual keyboard service to the virtual blockchain user wallet, and provide an on-chain service to the user by linking the on-chain user wallet with the virtual blockchain user wallet at preset link timing, and memory configured to store the on-chain user wallet and the virtual blockchain user wallet.

The processor may be configured to charge a lending fee for the on-chain user wallet and the virtual blockchain user wallet to the user at intervals of a preset period.

An off-chain address at which the virtual blockchain user wallet is created may be identical to an on-chain address at which the on-chain user wallet is created.

The user may use the on-chain service based on the virtual blockchain user wallet without requiring on-chain interaction.

The user may access the virtual blockchain user wallet using both a public key provided from a service provider of the virtual keyboard service and a private key for user authentication, and may then use the on-chain service.

The service provider may store pubic keys and private keys for respective users required for accessing corresponding on-chain user wallets.

The cryptocurrency may correspond to a first token that is a keyboard token usable in the virtual keyboard service, and the first token may be exchangeable with a second token that is a governance token capable of being encashed in a cryptocurrency exchange.

The virtual keyboard service may be configured to mine cryptocurrency in conformity with keyboard usage that is measured while the user accesses an application based on a keyboard Non-Fungible Token (NFT) and uses a virtual keyboard, and to provide a reward corresponding to the mined cryptocurrency to the virtual blockchain user wallet of the user.

The virtual keyboard service may be configured to mine the cryptocurrency in conformity with usage of each word corresponding to a word NFT purchased by the user, and to provide a reward corresponding to the mined cryptocurrency to the virtual blockchain user wallet of the user.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an operation flowchart illustrating a method for providing a virtual keyboard service of paying cryptocurrency rewards using a user wallet provided by a service provider according to an embodiment of the present disclosure;

FIG. 2 is a diagram illustrating examples of on-chain user wallets and virtual blockchain user wallets according to the present disclosure;

FIG. 3 is a diagram illustrating an example of differences between user wallet creating subjects, user wallet holding subjects, and user wallet information possessing subjects by comparing the present disclosure with conventional technology;

FIG. 4 is an operation flowchart illustrating in detail a process of providing cryptocurrency rewards in a method for providing a virtual keyboard service according to an embodiment of the present disclosure;

FIG. 5 is a diagram illustrating examples of a cryptocurrency mining volume and a transaction amount of money based on the usage of each word according to the present disclosure;

FIGS. 6 to 8 are diagrams illustrating examples of keyboard NFT attributes and keyboard NFT capabilities corresponding thereto according to the present disclosure;

FIG. 9 is a diagram illustrating an example of a keyboard NFT grade according to the present disclosure;

FIG. 10 is a diagram illustrating examples of keyboard NFT levels according to the present disclosure;

FIG. 11 is a diagram illustrating an example of keyboard NFT reinforcement according to the present disclosure;

FIG. 12 is a diagram illustrating an example of NFT lending according to the present disclosure;

FIG. 13 is a diagram illustrating examples of elements for changing a cryptocurrency mining volume according to the present disclosure;

FIG. 14 is a diagram illustrating an example of a virtual keyboard according to the present disclosure;

FIG. 15 is a diagram illustrating an example of a virtual keyboard to which a brand theme is applied according to the present disclosure;

FIG. 16 is a diagram illustrating an example of a keyboard NFT according to the present disclosure;

FIG. 17 is a diagram illustrating an example of keyboard NFT minting according to the present disclosure;

FIG. 18 is a diagram illustrating examples of a function provided through a virtual keyboard according to the present disclosure;

FIGS. 19 to 25 are diagrams illustrating examples of functions provided through an application according to the present disclosure;

FIG. 26 is an operation flowchart illustrating in detail a process of increasing a keyboard NFT level according to the present disclosure;

FIG. 27 is an operation flowchart illustrating in detail an example of a process of recovering the durability of a keyboard NFT according to the present disclosure;

FIG. 28 is an operation flowchart illustrating in detail an example of a keyboard NFT reinforcement process according to the present disclosure;

FIG. 29 is an operation flowchart illustrating in detail an example of an NFT minting process according to the present disclosure;

FIGS. 30 and 31 are diagrams illustrating an example of a process of switching a virtual keyboard service in a point mode to a virtual keyboard service in a cryptocurrency mining mode according to the present disclosure;

FIG. 32 is a diagram illustrating an example of a process of switching a service before application of a blockchain to a service after application of the blockchain according to the present disclosure;

FIG. 33 is a diagram illustrating an example of a process of selectively providing the type of cryptocurrency according to the present disclosure;

FIG. 34 is a diagram illustrating an example of a system for providing a virtual keyboard service of paying cryptocurrency rewards using a user wallet provided by a service provider according to an embodiment of the present disclosure; and

FIG. 35 is a block diagram illustrating an example of an apparatus for providing a virtual keyboard service of paying cryptocurrency rewards using a user wallet provided by a service provider according to an embodiment of the present disclosure.

### DETAILED DESCRIPTION OF EMBODIMENTS

Hereinafter, embodiments of the present disclosure will be described in detail with reference to the attached drawings. Repeated descriptions and descriptions of known functions and configurations which have been deemed to make the gist of the present disclosure unnecessarily obscure will be omitted below. It should be noted that the same reference numerals are used to designate the same or similar elements throughout the drawings.

Prior to the following detailed description of the present disclosure, it should be noted that the terms and words used in the specification and the claims should not be construed as being limited to ordinary meanings or dictionary definitions. In accordance with the principle that the inventor can appropriately define the concepts of terms to describe the disclosure in the best manner, the present disclosure should be construed in a manner that complies with the technical ideas and concepts of the disclosure. Specific structural and functional descriptions of embodiments of the present disclosure disclosed herein are only for illustrative purposes of the preferred embodiments of the present disclosure, and the present description is not intended to represent all of the technical spirit of the present disclosure. On the contrary, the present disclosure is intended to cover not only the exemplary embodiments, but also various alternatives, modifications, equivalents and other embodiments that may be included within the spirit and scope of the present disclosure as defined by the appended claims. It will be understood that, although the terms “first” and “second” may be used herein to describe various components, these components are not limited by these terms, and these terms are only used to distinguish one component from another component.

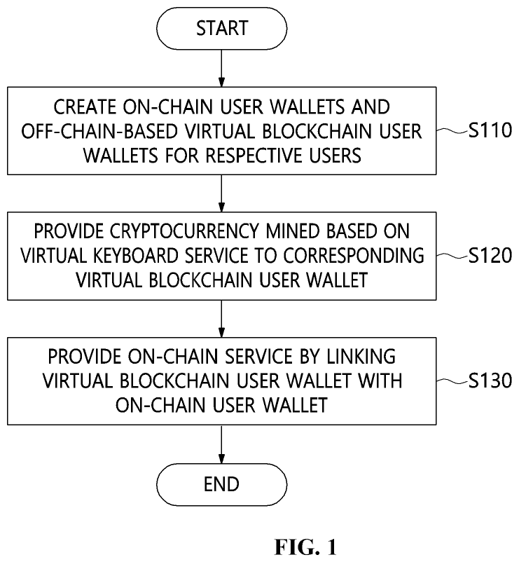

FIG. 1 is an operation flowchart illustrating a method for providing a virtual keyboard service of paying cryptocurrency rewards using a user wallet provided by a service provider according to an embodiment of the present disclosure.

Referring to FIG. 1, the method for providing a virtual keyboard service of paying cryptocurrency rewards using a user wallet provided by a service provider according to the embodiment of the present disclosure creates an on-chain user wallet and an off-chain-based virtual blockchain user wallet which match each other, and lends the created user wallets to a user who uses the virtual keyboard service at step S110.

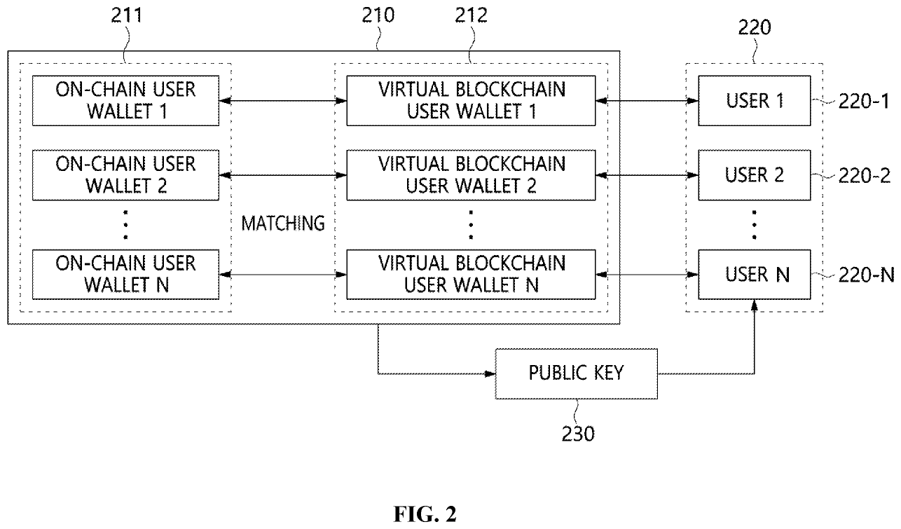

That is, in the present disclosure, as illustrated in FIG. 2, a service provider 210 that provides the virtual keyboard service may create, on an on-chain network 211, a number of user wallets identical to the number of users 220 who use the virtual keyboard service, may create, on an off-chain network 212, a number of virtual blockchain user wallets identical to the number of users 220, and may lend the created user wallets to the users 220.

In this case, the on-chain user wallets may be created on the blockchain and then used for actual cryptocurrency transactions, and the virtual blockchain user wallets may be used to allow the users 220 to use the on-chain service without making on-chain access.

For example, user 1 220-1 may access virtual blockchain user wallet 1 assigned thereto on the off-chain network 212, and may then check details or records of his or her cryptocurrency assets in the actual blockchain.

That is, the service provider of the virtual keyboard service according to the present disclosure may be the subject that actually creates and holds on-chain user wallets, and may function to register and manage transaction details, which are used in real time by the corresponding user through the virtual blockchain user wallet, based on the on-chain user wallet matching the virtual blockchain user wallet.

By means of this, the service provider may act as an intermediary in performing service tasks such as securely storing and exchanging the cryptocurrency assets of the users 220, and may provide convenience to the users 220 because the users 220 do not need to directly perform on-chain interaction.

In this case, an off-chain address at which the virtual blockchain user wallet is created may be identical to an on-chain address at which the on-chain user wallet is created.

That is, because the address of the virtual blockchain user wallet created on the off-chain is identical to the address of the on-chain user wallet, external control may be performed such that only deposit of cryptocurrency is possible.

In this case, the on-chain user wallet and the virtual blockchain user wallet may match each other.

For example, referring to FIG. 2, a number of on-chain user wallets identical to the number of users 220 may be created on the on-chain network 211, and a number of virtual blockchain user wallets identical to the number of users 220 may be created on the off-chain network 212, after which the created on-chain user wallets and the created virtual blockchain user wallets may match each other for respective users.

Further, although not illustrated in FIG. 1, the method for providing a virtual keyboard service of paying cryptocurrency rewards using a user wallet provided by a service provider according to the embodiment of the present disclosure may charge lending fees for the on-chain user wallets and the virtual blockchain user wallets to the users at intervals of a preset period.

As described above, because the concept of the present disclosure is to allow the service provider to act as an intermediary in performing service tasks such as securely storing and exchanging the cryptocurrency assets of respective users, lending fees for the on-chain user wallets and the virtual blockchain user wallets that are provided for the service tasks may be charged, with the result that profit may be created.

Furthermore, the method for providing a virtual keyboard service of paying cryptocurrency rewards using a user wallet provided by a service provider according to the embodiment of the present disclosure may provide cryptocurrency that is mined while the corresponding user uses the virtual keyboard service to the corresponding virtual blockchain user wallet at step S120.

In this case, the cryptocurrency may correspond to a first token, which is a token usable in the virtual keyboard service, and the first token may be exchanged with a second token, which is a governance token that can be encashed in a cryptocurrency exchange.

Therefore, the first token mined according to the present disclosure or the second token exchanged with the first token may be provided to and stored in the virtual blockchain user wallet so that the user can check the tokens on the off-chain.

In this case, details of a process of mining keyboard tokens through the virtual keyboard service according to the present disclosure will be described in detail later with reference to FIG. 4.

Furthermore, the method for providing a virtual keyboard service of paying cryptocurrency rewards using a user wallet provided by a service provider according to the embodiment of the present disclosure may provide an on-chain service to the corresponding user by linking the on-chain user wallet with the virtual blockchain user wallet at preset link timing at step S130.

In this case, the user may use the on-chain service using the virtual blockchain user wallet without requiring on-chain interaction.

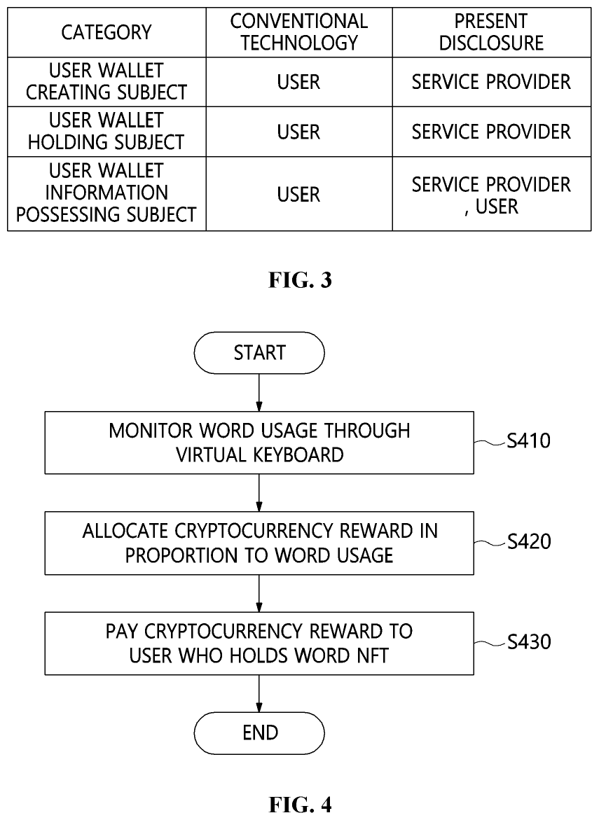

That is, referring to FIG. 3, conventional technology is disadvantageous in that both a subject who creates user wallets and a subject who holds the user wallets are the user, and thus interaction between the user and the service provider on the on-chain needs to be performed in order for the user to use an on-chain service such as storage, exchange, or transfer of cryptocurrency.

However, the present disclosure is characterized in that the service provider for providing the virtual keyboard service may act as an intermediary in performing blockchain recording, transaction tasks, etc. related to cryptocurrency owned by the user, and may provide only some information processed as the intermediary to the user. That is, even though the user does not personally access a blockchain network, the user may be provided with the on-chain service through the virtual blockchain user wallet on the off-chain.

In this case, because an ownership or the right for assets (cryptocurrency) stored in the virtual blockchain user wallet is held by the user, a subject who makes decision for transferring, receiving, or encashing the cryptocurrency may also be the user.

Here, the user may access the virtual blockchain user wallet using both a public key provided from the service provider of the virtual keyboard service and a private key for user authentication, and may then use the on-chain service.

For example, the public key may be account information of the user, and the private key for user authentication may be the password used to access the virtual blockchain user wallet.

For example, referring to FIG. 2, the service provider 210 according to the embodiment of the present disclosure may create virtual blockchain user wallets for respective users on the off-chain network 212, and may share public keys 230 for respective users with the users 220 so that the respective users 220 may access the virtual blockchain user wallets. Each of the users 220 may generate a public key for user authentication, and may access his or her virtual blockchain user wallet using the generated private key.

Here, the service provider may store the public keys and private keys for respective users required for accessing the on-chain user wallets.

For example, referring to FIG. 2, the service provider 210 according to the embodiment of the present disclosure may create on-chain user wallets for respective users 220 on the on-chain network 211, may generate the public keys 230 for respective users and private keys for allowing the service provider 210 himself or herself to access the on-chain user wallets, and may store the public keys 230 and the private keys.

As described above, the public keys 230 generated in this way may be shared with the users 220.

In this case, the virtual keyboard service may mine cryptocurrency corresponding to the first token in conformity with keyboard usage measured while a user who purchased a keyboard Non-Fungible Token (NFT) uses a virtual keyboard through an application, and may provide the mined cryptocurrency to the user as a reward.

Hereinafter, a process of providing cryptocurrency rewards in the method for providing a virtual keyboard service will be described in detail with reference to FIG. 4.

Referring to FIG. 4, the usage of each word entered using a virtual keyboard by each user who holds a keyboard NFT through the application is monitored at step S410.

Here, each user may install and execute the application, provided from a server, on his or her terminal, and may purchase a keyboard NFT at an NFT market accessed through the application and then use the virtual keyboard.

Therefore, when the users who purchased the keyboard NFTs at the NFT market activate their virtual keyboards and use the virtual keyboards on their user terminals, the usage of each word entered through each virtual keyboard may be monitored.

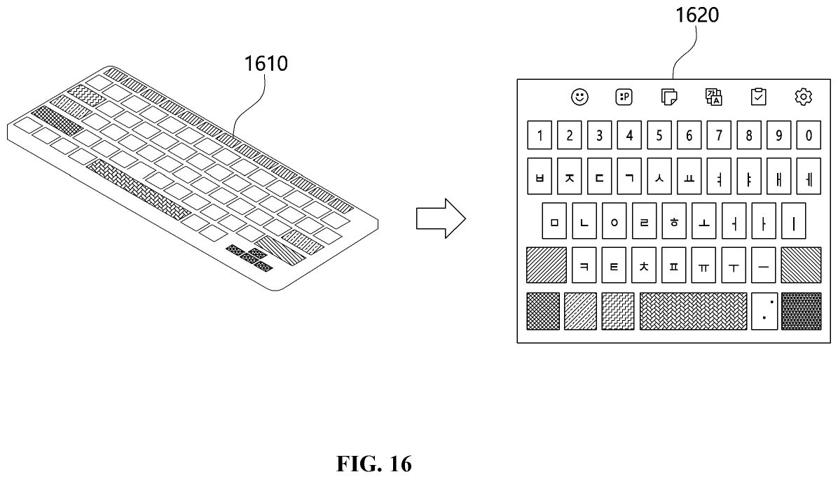

In this case, a keyboard NFT refers to a form in which, as illustrated in FIG. 16, a keyboard-type item 1610 is converted into a Non-Fungible Token (NFT) and is then sold, and such a keyboard NFT may be purchased at the NFT market that is accessible through the application installed on the corresponding user terminal.

For example, when the user purchases a keyboard NFT corresponding to the keyboard-type item 1610 at the NFT market, a virtual keyboard to which a virtual keyboard skin 1620 having a form similar to that of the keyboard-type item 1610 is applied may be activated on the user terminal, and may then be used. Therefore, when chats or communication based on the virtual keyboard to which the virtual keyboard skin 1620 is applied occur on the user terminal, such chats or communication may be monitored, and logs thereof may be stored or managed.

Here, the virtual keyboard according to the embodiment of the present disclosure may be developed and provided in conformity with the types of Software Development Kit (SDK) and Android Package Kit (APK).

Further, cryptocurrency corresponding to the first token may be mined in conformity with the usage of each word while the virtual keyboard is used at step S420.

Here, the cryptocurrency mined in the present disclosure may correspond to the type of an unstable token or a keyboard token independently issued by the provider of the service provided according to the present disclosure. Furthermore, the token issued in this way may be used for purchase, lending, minting, repair, recovery, or the like related to a word NFT, which will be described later, or the keyboard NFT, or may be converted into and used with external coins through the cryptocurrency exchange.

For example, when the user requests conversion of keyboard token A mined through the use of the virtual keyboard into external coin B, coin B corresponding to the value identical to keyboard token A requested to be converted may be paid by comparing the market price of keyboard token A with the market price of external coin B.

Furthermore, in consideration of keyboard NFT attributes varying with the usage of the virtual keyboard, a keyboard NFT capability may be measured, and cryptocurrency may be mined in conformity with the keyboard NFT capability while the virtual keyboard is used.

Here, the keyboard NFT attributes may include efficiency that is a positive attribute, the value of which is increased based on the usage of the virtual keyboard, and durability that is a negative attribute, the value of which is decreased based on the usage of the virtual keyboard.

Here, the keyboard NFT capability may be a value obtained by applying the current residual durability rate, calculated based on a default value for durability, to a value obtained by multiplying the usage of the virtual keyboard by the efficiency.

Here, the cryptocurrency may be mined to an extent corresponding to the capability at intervals of a preset unit time during the usage of the virtual keyboard.

Here, durability may be decreased as the usage of the virtual keyboard is increased, but may be recovered to a default value when cryptocurrency payment of for durability recovery occurs.

For example, the user may recover durability to the maximum value corresponding to a default value using a method of paying tokens or coins held in an electronic wallet, or may recover durability using a method of viewing an advertisement provided by the system or inviting a friend to the service according to the present disclosure.

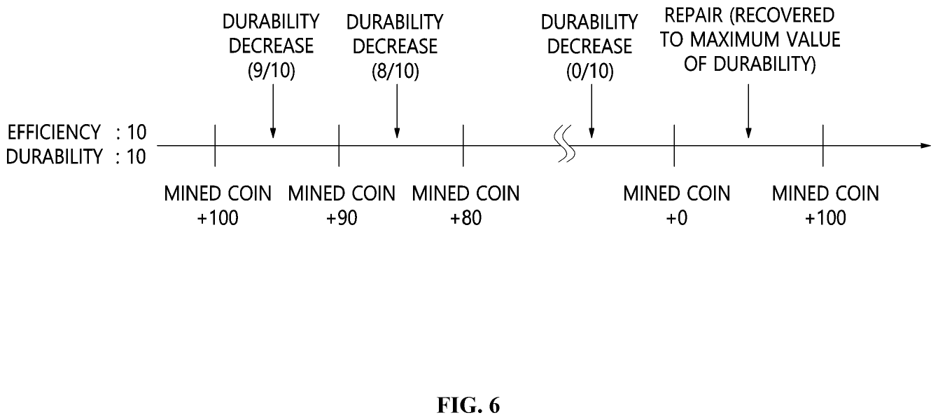

Hereinafter, keyboard NFT attributes and a cryptocurrency mining process corresponding thereto will be described in detail with reference to FIGS. 6 to 8.

First, FIG. 6 illustrates the mining volume of cryptocurrency that is mined per time as an NFT keyboard for which both default values for efficiency and durability are set to 10 is used.

For example, assuming that the usage of the virtual keyboard per unit time illustrated in FIG. 6 is 10, efficiency is 10 for an initial unit time, and the residual durability rate is 100%, and thus 100 coins corresponding to 10*10*1 may be mined.

However, for a subsequent unit time, durability is decreased by ‘1’, and thus the residual durability rate corresponds to 90%. Therefore, it can be seen that, for the corresponding unit time, only 90 coins corresponding to 10*10*0.9 are mined.

While the virtual keyboard is used in this way, durability is decreased at a certain rate, and thus cryptocurrency is no longer mined when the durability becomes 0.

Therefore, when durability becomes 0, cryptocurrency may be mined again after durability is recovered to the default value corresponding to the maximum value thereof through durability repair.

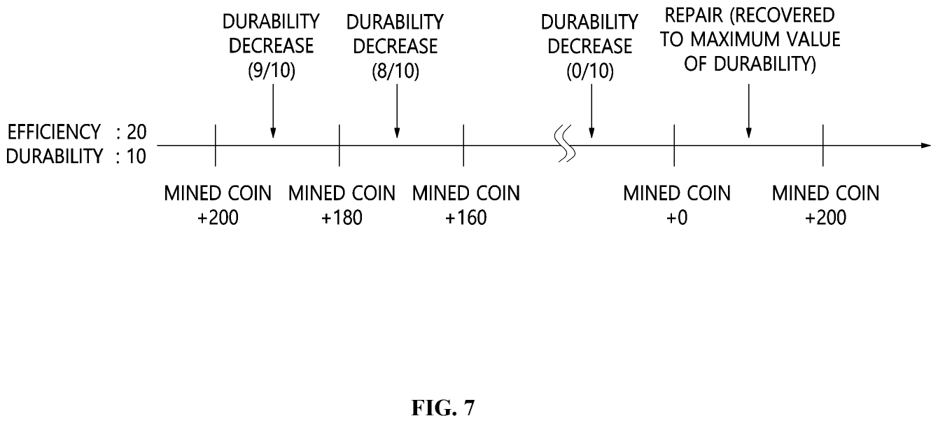

Further, FIG. 7 illustrates the mining volume of cryptocurrency that is mined per time as an NFT keyboard for which default values for efficiency and durability are set to 20 and 10, respectively, is used.

For example, assuming that the usage of the virtual keyboard per unit time illustrated in FIG. 7 is 10, efficiency is 20 for an initial unit time, and the residual durability rate is 100%, and thus 200 coins corresponding to 10*20*1 may be mined.

However, for a subsequent unit time, durability is decreased by ‘1’, and thus the residual durability rate corresponds to 90%. Therefore, for the corresponding unit time, only 180 coins corresponding to 10*20*0.9 may be mined.

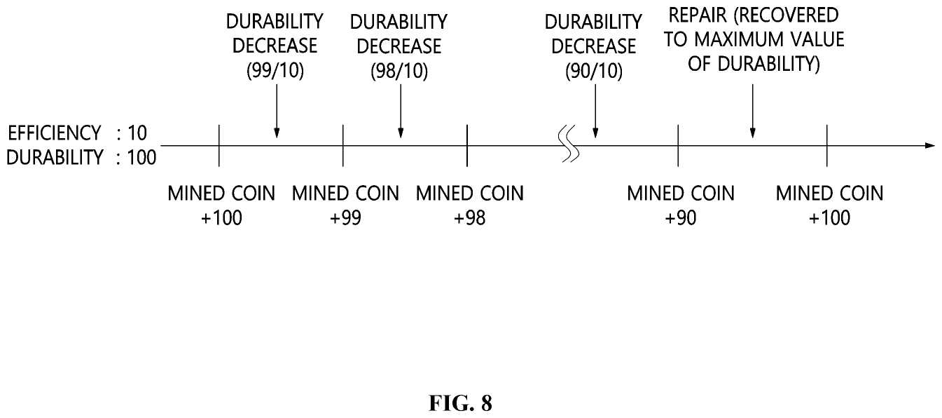

Further, FIG. 8 illustrates the mining volume of cryptocurrency that is mined per time as an NFT keyboard for which default values for efficiency and durability are set to 10 and 100, respectively, is used.

For example, assuming that the usage of the virtual keyboard per unit time illustrated in FIG. 8 is 10, efficiency is 10 for an initial unit time, and the residual durability rate is 100%, and thus 100 coins corresponding to 10*10*1 may be mined.

However, for a subsequent unit time, durability is decreased by ‘1’, and thus the residual durability rate corresponds to 99%. Therefore, for the corresponding unit time, only 99 coins corresponding to 10*10*0.99 may be mined.

In this case, the default value of the keyboard NFT attribute may be set differently depending on the keyboard NFT grade.

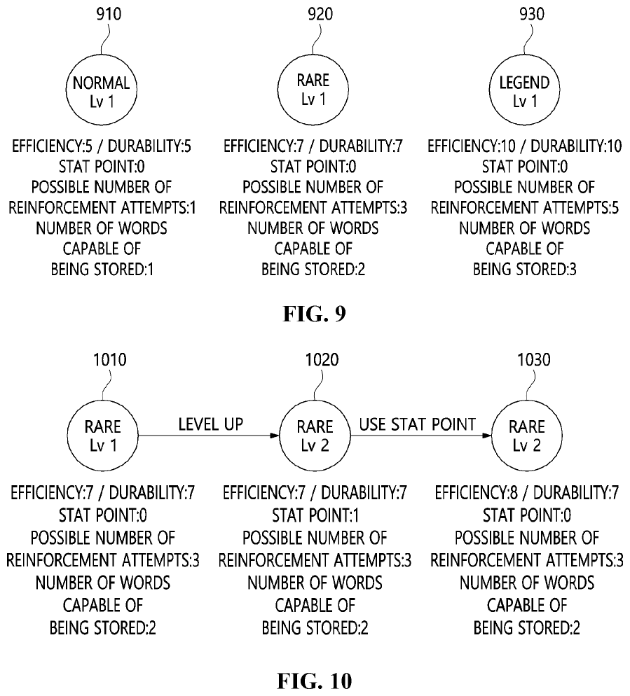

For example, referring to FIG. 9, the keyboard NFT grade according to the present disclosure may be classified into Normal, Rare, and Legend. ‘Normal’ may be the lowest grade, the next grade higher than ‘Normal’ may be ‘Rare’, and the next grade higher than ‘Rare’ may be ‘Legend’.

Here, when the default values of the keyboard NFT attributes of a keyboard NFT 910 corresponding to ‘Normal’ grade are set to efficiency 5/durability 5, the default values of the keyboard NFT attributes of a keyboard NFT 920 corresponding to ‘Rare’ grade may be set to efficiency 7/durability 7 higher than those in ‘Normal’ grade, and the default values of the keyboard NFT attributes of a keyboard NFT 930 corresponding to ‘Legend’ grade may be set to efficiency 10/durability 10 higher than those in ‘Rare’ grade.

Here, efficiency may be increased through a stat point given when the keyboard NFT level is increased based on an experience point provided in conformity with the usage of the virtual keyboard.

For example, referring to FIG. 10, assuming that the level of a keyboard NFT 1010 corresponding to ‘Rare’ grade is increased from level 1 to level 2 based on the experience point, a stat point of 1 may be provided. The stat point given in this way may be used to increase the keyboard NFT attributes. That is, as illustrated in FIG. 10, the stat point held in a keyboard NFT 1020 is used to increase efficiency, and thus the keyboard NFT attributes may be increased to efficiency 8/durability 7, as in the case of a keyboard NFT 1030.

In this case, the keyboard NFT level may correspond to the lower concept of the keyboard NFT grade, and the user may increase the keyboard NFT level by consuming a token or a coin corresponding to cryptocurrency. That is, leveling up of the keyboard NFT may be performed in response to the request of the user after the experience point provided to correspond to the usage of the virtual keyboard is accumulated to an extent corresponding to a preset level-up condition.

For example, assuming that an experience point corresponding to the preset level-up condition is 100, the user may use the virtual keyboard until the experience point is accumulated to 100. Thereafter, when the experience point becomes 100, notification of the fact that the leveling up of the corresponding NFT keyboard is possible may be provided to the user, and the user may request leveling up while paying tokens corresponding to cryptocurrency from the electronic wallet thereof. The level of the NFT keyboard for which leveling up is requested along with the payment of tokens may be increased after a certain period of time has elapsed.

In this case, the certain period of time required for leveling up may be set differently depending on the value of the current level.

For example, assuming that the time required to increase the level from level 1 to level 2 is 1 hour, the time required to increase the level from level 2 to level 3 may be set to 2 hours, and the time required to increase the level from level 3 to level 4 may be set to 3 hours.

Furthermore, when cryptocurrency payment for keyboard NFT reinforcement occurs, the keyboard NFT may be reinforced in consideration of the possible number of reinforcement attempts, assigned in conformity with the keyboard NFT grade, and a preset reinforcement success probability.

In this case, when the keyboard NFT reinforcement has succeeded, the default values of the keyboard NFT attributes may be increased.

Here, the keyboard NFT reinforcement may correspond to a method of increasing the default values of the keyboard NFT attributes separately from the keyboard NFT leveling up. However, in the case of the keyboard NFT level, the value of the level is displayed, which may be an index indicating how much the user has grown or developed the corresponding keyboard NFT.

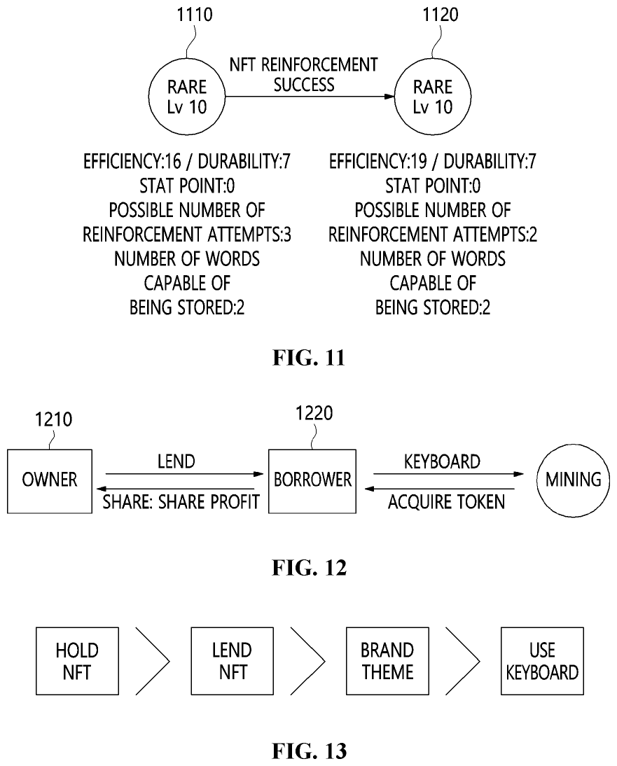

For example, referring to FIG. 11, a process of attempting to reinforce a keyboard NFT 1110 having level 10 in ‘Rare’ grade in which the default values of the keyboard NFT attributes are efficiency 16/durability 7 is illustrated. Here, because the possible number of reinforcement attempts, assigned to the keyboard NFT 1110 is 3, three reinforcement attempts are possible for the corresponding keyboard NFT 1110. When the user attempts to reinforce the keyboard NFT by paying cryptocurrency and succeeds in keyboard NFT reinforcement, the possible number of reinforcement attempts may be decreased to 2 while the default values of the keyboard NFT attributes are increased to efficiency 19/durability 7, as illustrated in FIG. 11.

Here, as the keyboard NFT grade is enhanced, the possible number of enhancement attempts may be increased.

That is, as illustrated in FIG. 9, because the possible number of enhancement attempts is differently assigned depending on the keyboard NFT grade, a higher grade keyboard NFT may have more opportunities to enhance the default value of the keyboard NFT attribute.

In this case, the keyboard NFT grade may be determined when the keyboard NFT is purchased, and the keyboard NFT grade determined once may not vary. Therefore, as the keyboard NFT grade is higher, the value of the NFT may be set to be greater.

For example, assuming that the keyboard NFT in ‘Normal’ grade can be purchased with 10 coins, the keyboard NFT in ‘Rare’ grade may be purchased with 100 coins, and the keyboard NFT in ‘Legend’ grade may be purchased with 1000 coins.

Here, the increase in the default values of the NFT attributes depending on the keyboard NFT reinforcement may be applied simultaneously with success in reinforcement. Further, an increment in the default value of the NFT attribute depending on the keyboard NFT reinforcement may be greater than that in the default value of the NFT attribute depending on the stat point given through NFT leveling up.

Further, when the fatigue level of the keyboard NFT reaches the maximum value thereof or when the available daily mining time of the user has expired, the mining of cryptocurrency may be stopped.

That is, the fatigue level may correspond to a concept identical to that of energy required for mining of cryptocurrency through the keyboard NFT. Therefore, when the fatigue level reaches ‘0’, it is determined that energy required for mining cryptocurrency is no longer present, and thus cryptocurrency may not be mined even though the user continues to use the virtual keyboard.

In this case, the fatigue level may be initialized at intervals of a preset initialization period.

For example, assuming that the preset initialization period is one day, the fatigue level may be initialized to allow the user to resume cryptocurrency mining when the next day arrives even though the fatigue level reaches 0 today and the user is unable to mine cryptocurrency any more.

Here, the available daily mining time may be the attribute of a limiting concept which is similar to the fatigue level, but is considered to be different therefrom.

For example, it is assumed that the fatigue level corresponds to a concept in which cryptocurrency mining is stopped when the default value of the fatigue level is set to 100 and the value of the fatigue level reaches 0 while gradually decreasing. On the other hand, the available daily mining time may correspond to a concept in which cryptocurrency mining is stopped when the default value of the available daily mining time is set to 8 hours and the time during which the user continuously mines cryptocurrency becomes 8 hours.

Here, when cryptocurrency payment for the recovery of the fatigue level occurs or when cryptocurrency payment for the recovery of the available daily mining time occurs, the fatigue level or the available daily mining time may be recovered to its default value.

Furthermore, the fatigue level or the available daily mining time may be recovered using a method of viewing an advertisement provided by the system or inviting a friend to the service according to the present disclosure.

Furthermore, a weight may be added to the keyboard NFT capability in consideration of whether a brand theme has been applied.

That is, while the brand theme is applied to the virtual keyboard, the weight may be added to the keyboard NFT capability, and thus the cryptocurrency mining volume may be increased.

Here, the brand theme may correspond to a virtual keyboard skin that is manufactured and provided through business affiliation, and may have the form of a skin that exposes a brand name, a brand logo or the like on the virtual keyboard.

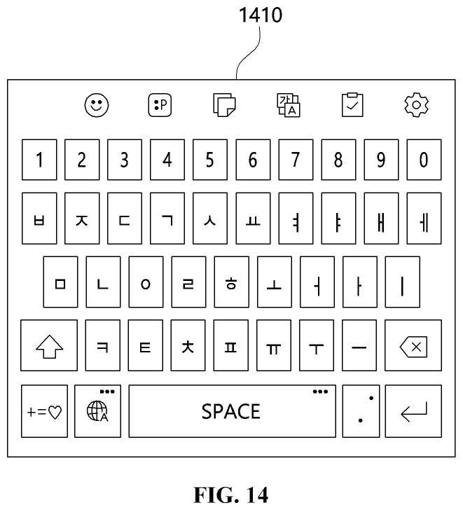

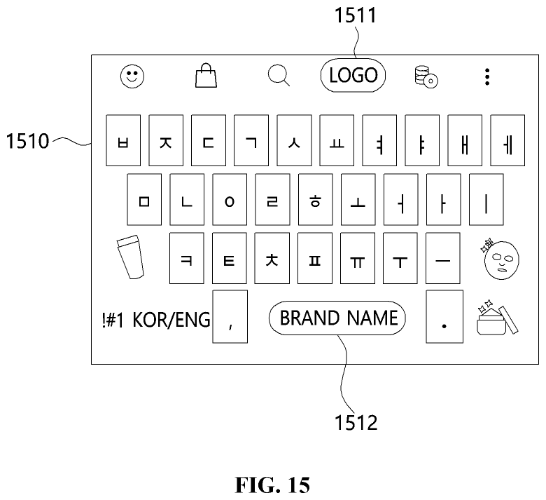

For example, assuming that a skin is not applied to a virtual keyboard 1410 illustrated in FIG. 14, it can be seen that a brand logo 1511 or a brand name 1512 is exposed through a skin on the virtual keyboard 1510 of FIG. 15 to which the brand theme is applied. Here, the brand logo 1511 or the brand name 1512 may be simply exposed information, or may function as a link to the homepage or the application of an affiliated company that provides the brand theme.

That is, the company that provides the brand theme may obtain the effect of advertising the brand thereof, and the user may add a weight to the keyboard NFT capability by applying the brand theme to the virtual keyboard, thus mining more cryptocurrency.

In this case, although, in FIG. 15, only examples of the brand logo 1511 or the brand name 1512 depending on the application of the brand theme have been handled, the application of the brand theme is not limited to such a configuration.

For example, the brand theme may be applied using a scheme for exposing a brand advertisement in a marginal space of the virtual keyboard or a scheme for exposing a character or a design indicating a specific brand on the virtual keyboard.

Furthermore, the brand theme may be distributed for free by the affiliated company for the purpose of advertising, or may be issued in the form of an NFT skin and may be operated as a limited edition of NFT having scarcity.

Further, the mined cryptocurrency may be paid as a reward to a user mapped to a word NFT acquired by converting an ownership (right) for the corresponding word into an NFT at step S430.

In this case, the word NFT may be acquired by converting an ownership for each word entered by the user through the virtual keyboard into an NFT. Therefore, the user who holds a specific word NFT may be provided with a reward depending on the usage of the corresponding word.

In other words, according to the present disclosure, when a user who holds a keyboard NFT additionally holds a word NFT, a cryptocurrency mining volume may be increased. For example, even though user A who holds only a keyboard NFT and user B who holds both a keyboard NFT and a word NET use the virtual keyboard for the same time period, the cryptocurrency mining volume of user B may be greater.

In this case, the mining volume of the cryptocurrency is increased in proportion to the usage of the word, but the mining volume of cryptocurrency may be increased in conformity with a preset ratio for the number of word NFTs for each word when multiple word NFTs are mapped to one user.

For example, assuming that, when one word NFT is held, coins corresponding to 100% of word usage are mined, coin mining may be set such that, when two word NFTs are held, coins corresponding to 90% of word usage are mined, and such that, when three word NFTs are held, coins corresponding to 80% of word usage are mined.

That is, it is assumed that, when one word NFT is held, one coin is mined depending on the word usage. In this case, when two word NFTs are held, 1.8 coins may be mined depending on the same word usage. When three word NFTs are held, 2.4 coins may be mined depending on the same word usage.

Here, as the word NFT grade is higher, the mining volume of cryptocurrency may be greater.

In this case, the word NFT grade may be set based on the usage of each word entered through the application, wherein a more frequently used word may be set to have a higher grade.

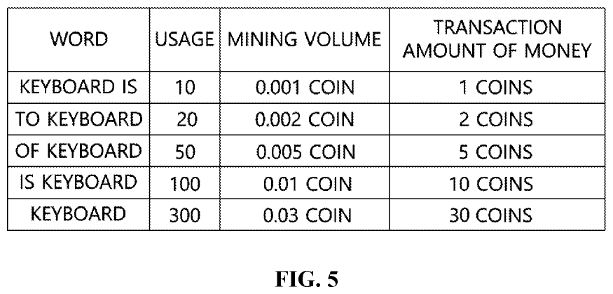

For example, FIG. 5 illustrates usages, mining volumes, and NFT transaction amounts of money for various word NFTs. According to the present disclosure, a word NFT corresponding to the most frequently used word ‘keyboard’ may be set to have the highest word NFT grade, and a word NFT corresponding to the least frequently used word ‘keyboard is’ may be set to have the lowest word NFT grade.

Here, as illustrated in FIG. 5, transaction amounts of memory for respective word NFTs may be determined in consideration of the usages of respective words. That is, a word NFT for a more frequently used word may be traded at a high price, whereas a word NFT for less frequently used word may be traded at a low price.

Therefore, the value of the word NFT may vary depending on an issue such as the popularity of a specific word or the increased usage of a specific word.

Here, one word NFT may be mapped to multiple users, and multiple word NFTs may be mapped to one user, wherein the maximum number of word NFTs that can be mapped to each user may be determined depending on the keyboard NFT grade held by each user.

For example, as illustrated in FIG. 9, the user who holds the keyboard NFT 910 in ‘Normal’ grade may hold one word NFT, the user who holds the keyboard NFT 920 in ‘Rare’ grade may hold two word NFTs, and the user who holds the keyboard NFT 930 in ‘Legend’ grade may hold three word NFTs. Therefore, a user who holds multiple keyboard NFTs may hold more word NFTs, and thus a cryptocurrency mining volume may be increased in proportion to the number of word NFTs.

Further, when cryptocurrency payment for minting occurs, two word NFTs mapped to a user who attempts minting may be combined. When minting has succeeded depending on the preset minting success probability, one higher-level word NFT, which is created through the combination, may be mapped to the user who attempted minting.

Here, minting may be the concept of creating user's own NFT. Therefore, the new NFT created through minting may be personally used by the user or may be sold to other users through the NFT market.

Here, word NFT minting may be attempted for word NFTs mapped to the user, that is, word NFTs held by the user.

For example, the user may obtain an ownership for a specific word using a method of purchasing a word NFT traded at an NFT market, may map the ownership for the specific word to the user himself or herself, and may acquire a higher-level word NFT at a certain probability by combining word NFTs mapped to the user.

In this case, the word NFT minting may be attempted for two word NFTs having the same stem or root among the word NFT held by the user.

For example, referring to FIG. 5, a user who holds both a word NFT corresponding to ‘keyboard is’ and a word NFT corresponding to ‘of keyboard’ may attempt to mint the two word NFTs, and may then acquire a word NFT corresponding to ‘keyboard’ traded at a higher price.

In another example, even though the user has a word NFT corresponding to ‘of mouse’, the word NFT has the stem or root that is not identical to that of the word NFT corresponding to ‘keyboard is’, and thus the corresponding minting may fail after having attempted or, alternatively, the attempt itself may be impossible.

Here, the keyboard NFT minting may be performed.

For example, when cryptocurrency payment for keyboard NFT minting occurs, two different keyboard NFTs held by the user may be combined, and a new type of keyboard NFT, which is created through the combination, may be provided to the user when minting has succeeded depending on the preset minting success probability.

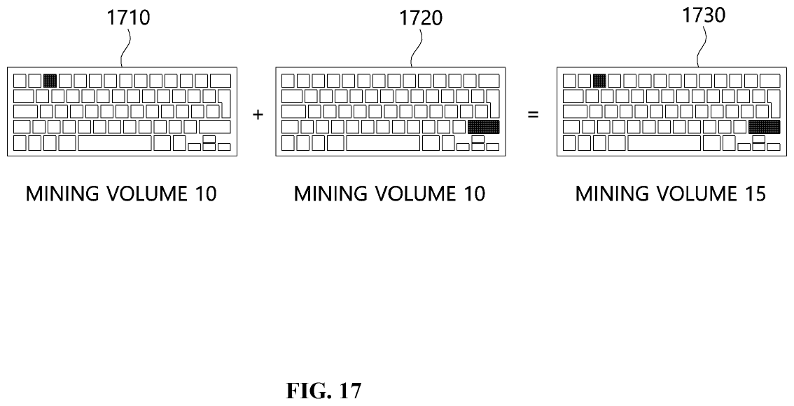

Referring to FIG. 17, minting is performed in a form in which two different keyboard NFTs 1710 and 1720 held by the user are combined with each other, and thus a new keyboard NFT 1730 may be created.

Here, in order to attempt word NFT minting or keyboard NFT minting, there is a need to pay cryptocurrency, thus enabling a certain amount of tokens held in the electronic wallet of the user to be burned when minting is attempted. Further, minting may succeed depending on the preset success probability, and a higher-level word NFT or a new keyboard NFT may be created only when minting has succeeded.

In this case, minting success probabilities set to different values may be applied to word NFT minting and keyboard NFT minting, respectively.

Further, as a reward for word NFT lending, cryptocurrency may be paid to the user.

In this case, cryptocurrency may be paid to the user as a reward for keyboard NFT lending.

For example, the present disclosure may purchase, sell, and lend an NFT at the NFT market that is accessible through the application. When the user lends his or her own word NFT or keyboard NFT to another user, a reward (cryptocurrency) for NFT lending may be paid to the user using a scheme for sharing a part of a reward (token), mined by a borrower 1220 by using the virtual keyboard, with an owner 1210 who lends the NFT, as illustrated in FIG. 12.

When cryptocurrency mining volumes are compared with each other by summarizing the foregoing description, a relationship illustrated in FIG. 13 may be obtained.

That is, compared to a user who simply purchases only a word NFT or a keyboard NFT and uses a virtual keyboard, a user who uses a virtual keyboard to which a brand theme is applied may mine more cryptocurrency with respect to the same keyboard usage.

Furthermore, in order to mine more cryptocurrency for a usage time, the user may mine more cryptocurrency using a scheme for lending his or her own keyboard NFT to another user or a scheme for holding more word NFTs or more keyboard NFTs by purchasing or minting NFTs.

By means of the above-described method for providing a virtual keyboard service of paying cryptocurrency rewards using a user wallet provided by a service provider, user convenience may be maximized by allowing a user who uses a virtual keyboard service to exploit a virtual blockchain user wallet in an off-chain without requiring on-chain interaction inconvenient to the user.

Further, the service provider of the virtual keyboard service may perform an on-chain service on a blockchain while minimizing unnecessary interaction with the user.

Furthermore, there can be provided a service for earning money through communication between users, such as Communication-to-Earn (C2E), thus inducing active communication between family members, friends, or acquaintances and providing benefits based on the active communication.

Further, related rewards may be provided to users who hold word NFTs by converting words, which are chiefly used when a virtual keyboard service is provided, into NFTs and providing the NFTs.

Furthermore, there can be provided a virtual keyboard service in which a blockchain technology is introduced into a virtual keyboard used by a user terminal, thus providing differentiated customer benefits and experiences compared to a conventional point provision-based virtual keyboard service.

Furthermore, the present disclosure may provide more variety of terminal virtual keyboards used by multiple users depending on the amount of usage without being limited to the simple use of the terminal virtual keyboard.

Furthermore, the structure of a virtual keyboard service for paying cryptocurrency rewards to be switchable to a point-accumulative virtual keyboard service may be designed, thus effectively securing multiple customers.

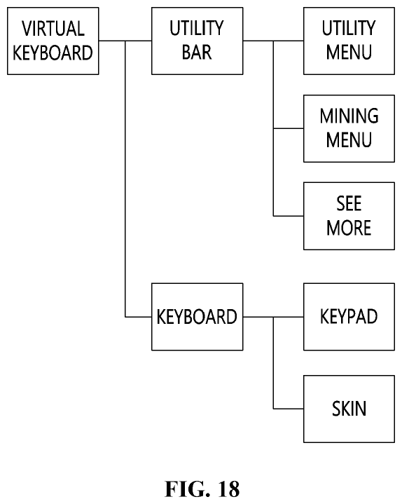

FIG. 18 is a diagram illustrating examples of a function provided through a virtual keyboard according to the present disclosure.

Referring to FIG. 18, the virtual keyboard according to the present disclosure may be separated into a utility bar for providing utility and a keyboard, based on a keypad that is the most basic function.

Here, the utility bar may provide functions classified into a utility menu, a mining menu, etc., and the keyboard may provide functions classified into a keypad and a skin.

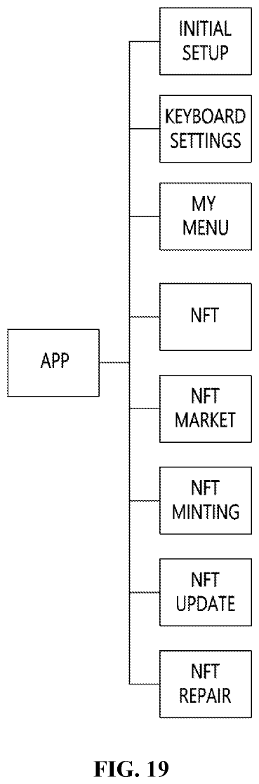

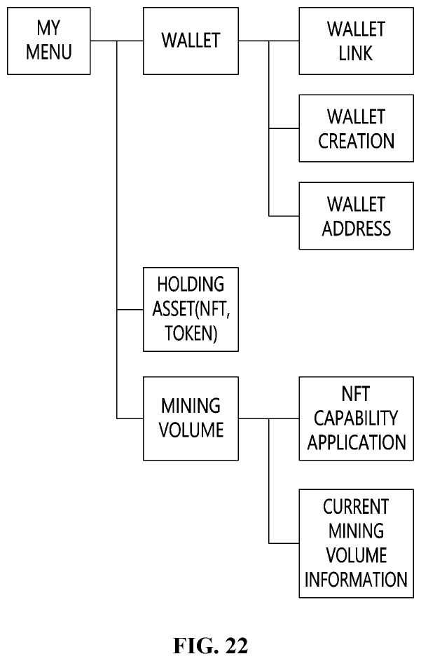

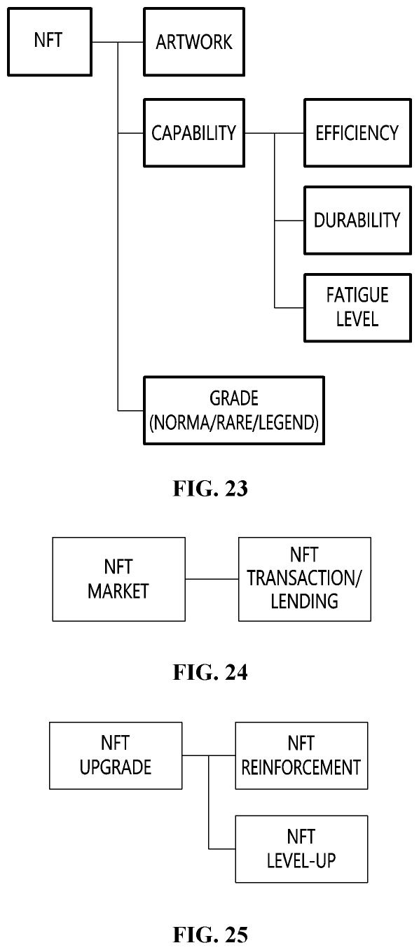

FIGS. 19 to 25 are diagrams illustrating examples of functions provided through an application according to the present disclosure.

First, referring to FIG. 19, the application for providing a virtual keyboard service according to the present disclosure may provide functions, such as initial setup, keyboard settings, My menu, NFT, NFT market, NFT minting, NFT upgrade, and NFT repair.

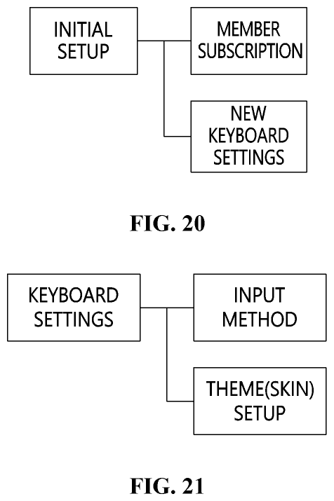

Referring to FIG. 20, the initial setup may provide functions such as member subscription or new keyboard setting, and the keyboard settings may provide functions such as an input method or theme (skin) setup.

Further, by means of My menu, functions such as wallet, holding asset, and a mining volume may be provided, wherein the wallet function may provide features such as wallet link, wallet creation, and wallet address, and the mining volume function may provide features such as the application of NFT capabilities and current mining volume information.

Furthermore, the NFT function may provide features such as artwork, a capability, and a grade, wherein the capability feature may provide information related to efficiency, durability, and a fatigue level for NFT.

Furthermore, the NFT market function may provide functions such as NFT transaction, lending, and sales, and the NFT upgrade function may enable NFT reinforcement or NFT leveling up.

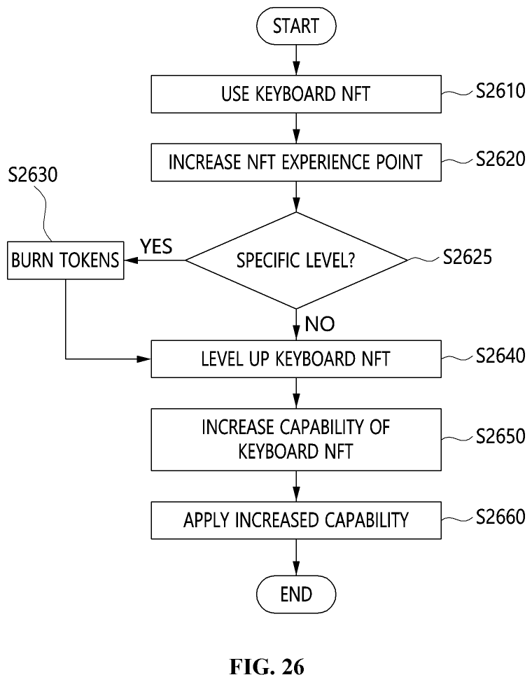

FIG. 26 is an operation flowchart illustrating in detail a process of increasing a keyboard NFT level according to the present disclosure.

Referring to FIG. 26, when a user who holds a keyboard NFT uses a virtual keyboard at step S2610, an experience point for the keyboard NFT may be increased depending on the usage of the virtual keyboard at step S2620.

Thereafter, when it is desired to level up in response to a level-up request made by the user, whether the current keyboard NFT level is a specific level may be determined at step S2625.

When it is determined at step S2625 that the current keyboard NFT level is the specific level, token burning is conducted by requesting the user to pay a token at step S2630, after which leveling up the keyboard NFT may be performed at step S2640.

When it is determined at step S2625 that the current keyboard NFT level is not the specific level, leveling up the keyboard NFT may be performed without separately requesting the user to pay a token at step S2640.

Thereafter, when the keyboard NFT attribute is increased based on a stat point given with the increase in the keyboard NFT level, the keyboard NFT capability may be increased at step S2650, after which the increased keyboard NFT capability may be applied to cryptocurrency mining depending on the subsequent use of the virtual keyboard at step S2660.

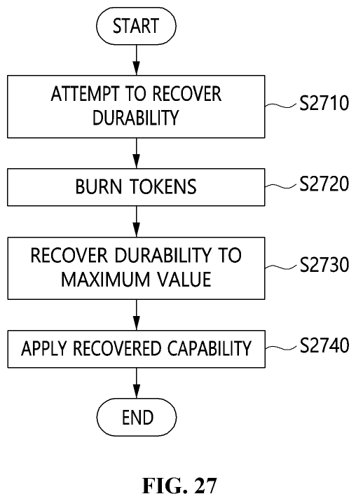

FIG. 27 is an operation flowchart illustrating in detail an example of a process of recovering the durability of a keyboard NFT according to an embodiment of the present disclosure.

Referring to FIG. 27, when an attempt to recover the durability of the keyboard NFT is made by the user at step S2710, the method may request the user to pay cryptocurrency for durability recovery and burn tokens corresponding to the request at step S2720.

Thereafter, when it is determined that the tokens have burned, the durability of the keyboard NFT may be recovered to a default value, that is, the maximum value, at step S2730, and the keyboard NFT capability may be recovered depending on the recovered durability at step S2740.

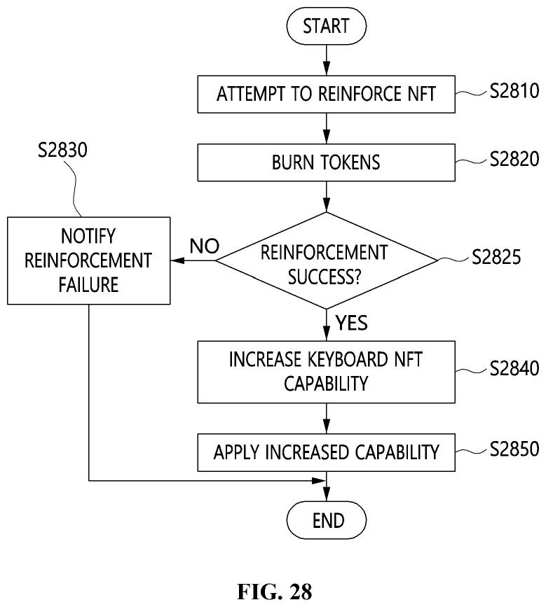

FIG. 28 is an operation flowchart illustrating in detail an example of a keyboard NFT reinforcement process according to the present disclosure.

Referring to FIG. 28, when an attempt to reinforce the keyboard NFT is made by the user at step S2810, the method may request the user to pay cryptocurrency for keyboard NFT reinforcement and burn tokens corresponding to the request at step S2820.

Here, in consideration of whether the possible number of reinforcement attempts assigned to the keyboard NFT requested to be reinforced is present, the method may request the user to pay cryptocurrency when it is determined that the possible number of reinforcement attempts is present.

Thereafter, when the burning of tokens has been verified, keyboard NFT reinforcement is performed depending on the preset reinforcement success probability, and thereafter whether reinforcement has succeeded may be determined at step S2825.

When it is determined at step S2825 that reinforcement has succeeded, a keyboard NFT capability may be increased by increasing a keyboard NFT attribute at step S2840, and the increased keyboard NFT capability may be applied to subsequent cryptocurrency mining depending on the usage of the virtual keyboard at step S2850.

In this case, depending on the success in the keyboard NFT reinforcement, the possible number of reinforcement attempts assigned to the corresponding keyboard NFT may be decreased by 1.

On the other hand, when it is determined at step S2825 that reinforcement has failed, the method may notify the user of the failure in reinforcement, and may terminate the process at step S2830.

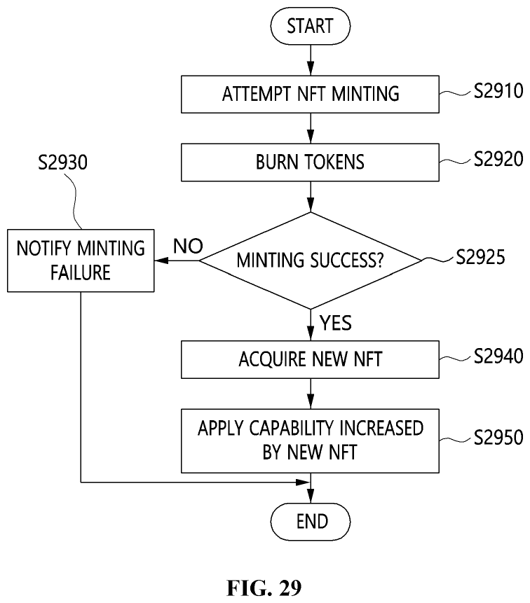

FIG. 29 is an operation flowchart illustrating in detail an example of an NFT minting process according to the present disclosure.

Referring to FIG. 29, when an attempt to mint a word NFT or a keyboard NFT is made by the user at step S2910, the process may request the user to pay cryptocurrency for NFT minting and burn tokens corresponding to the request at step S2920.

Thereafter, when the burning of the tokens has been verified, NFT minting is performed depending on the preset minting success probability, and thereafter whether minting has succeeded may be determined at step S2925.

In this case, the minting success probability for the word NFT and the minting success probability for the keyboard NFT may be set to different values.

When it is determined at step S2925 that minting has succeeded, a new keyboard NFT or a new word NFT (higher-level word NFT) created through minting may be provided and mapped to the user at step S2940, and a capability increased by the new NFT, newly provided to the user, may be applied to subsequent cryptocurrency mining depending on the usage of the virtual keyboard at step S2950.

For example, the keyboard NFT capability increased by the new keyboard NFT may be applied to subsequent cryptocurrency mining or, alternatively, a cryptocurrency mining volume increased by the new word NFT (higher-level word NFT) may be applied to subsequent cryptocurrency mining.

On the other hand, when it is determined at step S2925 that minting has failed, the method may inform the user of the failure in minting, and may terminate the process at step S2930.

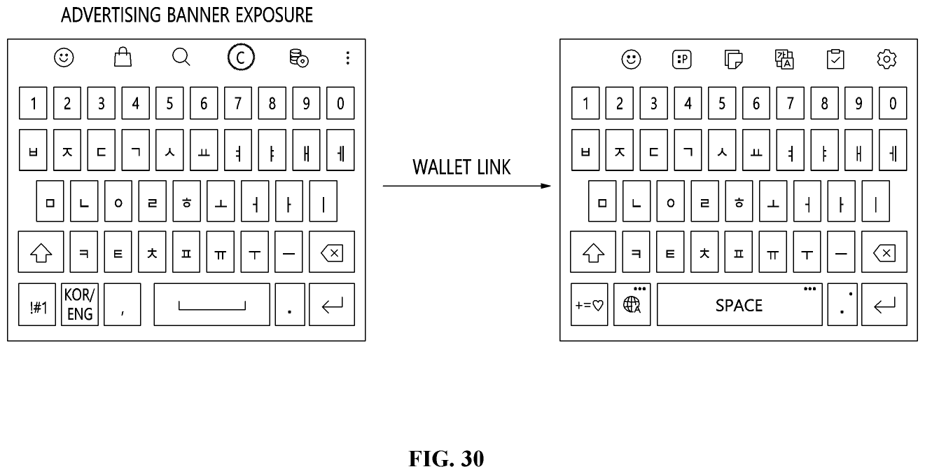

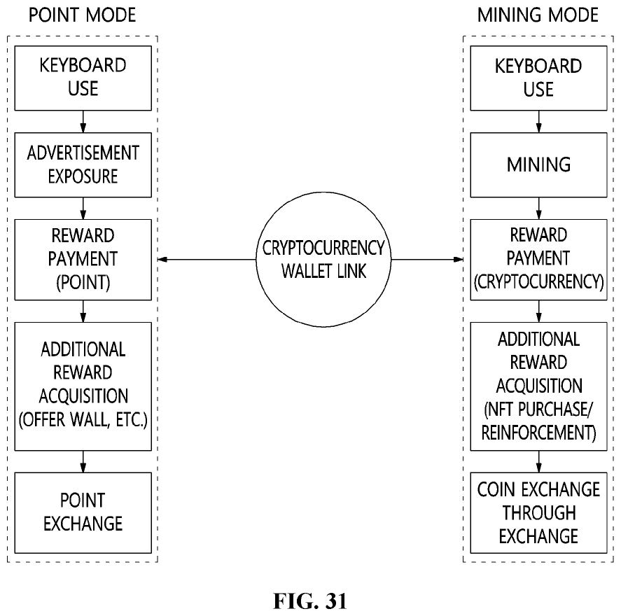

FIGS. 30 and 31 are diagrams illustrating an example of a process of switching a virtual keyboard service in a point mode to a virtual keyboard service in a cryptocurrency mining mode according to the present disclosure.

First, referring to FIG. 30, an example in which the virtual keyboard in the point mode switches to the virtual keyboard in the cryptocurrency mining mode depending on the service switching is illustrated.

For example, in the virtual keyboard service in the point mode, an advertisement may be exposed on the virtual keyboard while a user uses the virtual keyboard, as illustrated in FIG. 31. As the advertisement is exposed on the virtual keyboard in this way, a point may be paid as a reward, and additional rewards may also be generated through events such as offer walls, attendance check-ins, and application of a brand theme, which are determined by the user's selection in addition to simple advertisement exposure. The rewards accumulated in this way, that is, points, may be exchanged with points that can be used as currency in a specific application or a specific medium.

Referring to FIG. 31, when the service switches from the virtual keyboard service in the point mode to the virtual keyboard service in the cryptocurrency mining mode, an electronic wallet may be linked with the virtual keyboard, and the form of a reward may be converted from points to cryptocurrency. Cryptocurrency converted in this way may be exchanged with various types of coins through an exchange, and may then be used.

Further, after the service has switched, cryptocurrency may be mined while the user uses the virtual keyboard based on the purchase of the keyboard NFT.

In this case, the virtual keyboard service in the point mode and the virtual keyboard service in the cryptocurrency mining mode may be provided through different applications, and a member system may also be separately managed. Further, when a request to switch the service mode is made by the user, service switching from the point mode to the cryptocurrency mining mode may be performed. Unless a separate request is made by the user, service switching may not be performed.

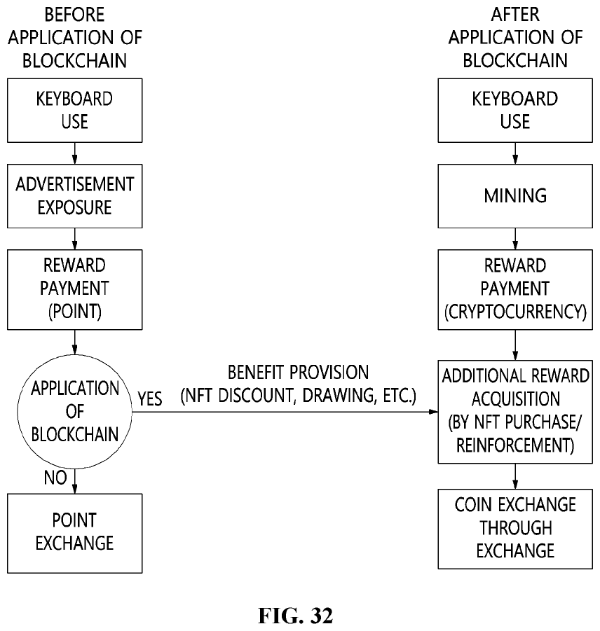

FIG. 32 is a diagram illustrating an example of a process of switching a service before application of a blockchain to a service after application of the blockchain according to the present disclosure.

Referring to FIG. 32, the process of operating a virtual keyboard service in a point mode, such as that shown in FIG. 31, and then switching the service mode from the virtual keyboard service in the point mode to a virtual keyboard service in a cryptocurrency mining mode depending on the user's selection is illustrated.

Here, upon service switching, benefits may be differentially paid for respective points accumulated by using the virtual keyboard service in the point mode.

For example, when the service is used after application of a blockchain, benefits, such as discounting cryptocurrency expense that occurs in attempting to mint NFT or assigning priority in the occurrence of an event such as drawing, may be paid.

Furthermore, as illustrated in FIG. 32, when it is impossible to apply a blockchain and then the virtual keyboard service before application of the blockchain is not switched to the virtual keyboard service after application of the blockchain, the accumulated points may be exchanged with points that can be used as currency in a specific application or a specific medium.

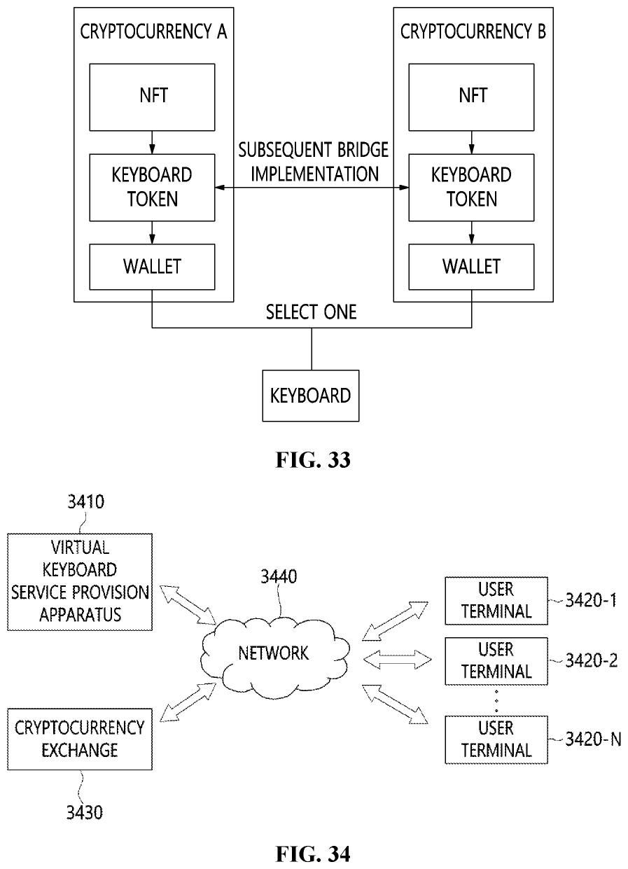

FIG. 33 is a diagram illustrating an example of a process of selectively providing the type of cryptocurrency according to the present disclosure.

Referring to FIG. 33, the present disclosure may provide an extended type of service so that various types of external coins can be supported through a virtual keyboard service for paying cryptocurrency rewards based on a word NFT.

For example, as illustrated in FIG. 33, an NFT may be individually issued in a chain corresponding to cryptocurrency A and a chain corresponding to cryptocurrency B, and a keyboard token may also be individually issued as a keyboard token corresponding to cryptocurrency A and as a keyboard token corresponding to cryptocurrency B.

Therefore, the service may be configured such that an NFT in the chain of cryptocurrency A is purchased with cryptocurrency A and an NFT in the chain of cryptocurrency B is purchased with cryptocurrency B.

Thereafter, as illustrated in FIG. 33, the service may be extended such that various coins can be supported in the service through a bridge between keyboard tokens occurring in respective chains.

FIG. 34 is a diagram illustrating an example of a system for providing a virtual keyboard service of paying cryptocurrency rewards using a user wallet provided by a service provider according to an embodiment of the present disclosure.

Referring to FIG. 34, the system for providing a virtual keyboard service of paying cryptocurrency rewards using a user wallet provided by a service provider according to the embodiment of the present disclosure includes a virtual keyboard service provision apparatus 3410, user terminals 3420-1 to 3420-N, a cryptocurrency exchange 3430, and a network 3440.

The virtual keyboard service provision apparatus 3410 may create an on-chain user wallet and an off-chain-based virtual blockchain user wallet, which match each other, and may lend the created user wallets to a user who uses the virtual keyboard service.

In this case, an off-chain address at which the virtual blockchain user wallet is created may be identical to an on-chain address at which the on-chain user wallet is created.

Further, the virtual keyboard service provision apparatus 3410 may charge a lending fee for the on-chain user wallet and the virtual blockchain user wallet to the user at intervals of a preset period.

Furthermore, the virtual keyboard service provision apparatus 3410 may provide the virtual blockchain user wallet with cryptocurrency that is mined while the user uses the virtual keyboard service.

In this case, the cryptocurrency may correspond to a first token, which is a token usable in the virtual keyboard service, and the first token may be exchanged with a second token, which is a governance token that can be encashed in a cryptocurrency exchange.

Furthermore, the virtual keyboard service provision apparatus 3410 may provide an on-chain service to the user by linking the on-chain user wallet with the virtual blockchain user wallet at preset link timing.

In this case, the user may use the on-chain service using the virtual blockchain user wallet without requiring on-chain interaction.

Here, the user may access the virtual blockchain user wallet using both a public key provided from the service provider of the virtual keyboard service and a private key for user authentication, and may then use the on-chain service.

Here, the service provider may store public keys and private keys for respective users required for accessing the on-chain user wallets.

Here, the virtual keyboard service may access the application based on the keyboard NFT, may mine cryptocurrency in conformity with keyboard usage measured while the user uses a virtual keyboard, and may provide a reward corresponding to the mined cryptocurrency to the virtual blockchain user wallet of the user.

Here, the virtual keyboard service may mine cryptocurrency corresponding to the usage of each word corresponding to a word NFT purchased by the user, and may provide a reward corresponding to the cryptocurrency to the virtual blockchain user wallet of the user.

Each of the user terminals 3420-1 to 3420-N may access the NFT market through an application provided by the user from the virtual keyboard service provision apparatus 3410, may activate a virtual keyboard based on a keyboard NFT purchased at an NFT market, and may mine cryptocurrency in conformity with the word usage of the corresponding word NFT by purchasing a word NFT at the NFT market.

For example, each of the user terminals 3420-1 to 3420-N may be a device that is connected to a communication network and on which the application according to the embodiment can be executed, and may be any of all information communication devices, multimedia terminals, and Internet Protocol (IP) terminals, without being limited to mobile communication terminals. Further, each user terminal may be any of mobile terminals having various mobile communication specifications, such as a mobile phone, a Portable Multimedia Player (PMP), a Mobile Internet Device (MID), a smart phone, a tablet computer (PC), a notebook, a Netbook, a Personal Digital Assistant (PDA), and data communication equipment.

Furthermore, each of the user terminals 3420-1 to 3420-N may receive various types of information such as number and character information, and may deliver signals that are input in relation to the setting of various functions and the control of the functions of the user terminals 3420-1 to 3420-N to a control unit through an input unit. The input unit of each of the user terminals 3420-1 to 3420-N may be configured to include at least one of a keypad or a touch pad for generating an input signal in response to the user's touch or manipulation, or a combination thereof. Here, the input unit of each of the user terminals 3420-1 to 3420-N may be configured in the form of a single touch panel (or a touch screen), together with the display unit of the corresponding one of the user terminals 3420-1 to 3420-N, and may simultaneously perform both an input function and a display function. Further, the input unit of each of the user terminals 3420-1 to 3420-N may be implemented as all types of input means that can be developed in the future in addition to an input device such as a keyboard, a keypad, a mouse, or a joystick.

Furthermore, the display unit of each of the user terminals 3420-1 to 3420-N may display information about a series of operating states and operation results which occur while each of the user terminals 3420-1 to 3420-N performs functions. Furthermore, the display unit of each of the user terminals 3420-1 to 3420-N may display the menu of the corresponding one of the user terminals 3420-1 to 3420-N, user data entered by the user, etc. Here, the display unit of each of the user terminals 3420-1 to 3420-N may be implemented as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a three-dimensional (3D) display, or the like. Here, when the display unit of each of the user terminals 3420-1 to 3420-N is implemented as a touch screen, the display unit of the corresponding one of the user terminals 3420-1 to 3420-N may perform some or all of the functions of the input unit of the corresponding one of the user terminals 3420-1 to 3420-N. In particular, the display unit of each of the user terminals 3420-1 to 3420-N according to the present disclosure may display information related to the execution of an interface and the application that are provided to pay cryptocurrency rewards using the keyboard NFT on a screen.

Also, the storage unit of each of the user terminals 3420-1 to 3420-N is a device for storing data, includes a main memory unit and an auxiliary memory unit, and is capable of storing an application required for the functional operation of the user terminal. The storage unit of each of the user terminals 3420-1 to 3420-N may chiefly include a program area and a data area. Here, when each function is activated in response to a request from the user, each of the user terminals 3420-1 to 3420-N executes the corresponding applications under the control of the control unit and provides each function. In particular, the storage unit of each of the user terminals 3420-1 to 3420-N according to the present disclosure may store an Operating System (OS) for booting the corresponding one of the user terminals 3420-1 to 3420-N, the application for providing cryptocurrency rewards, etc. Furthermore, the storage of each of the user terminals 3420-1 to 3420-N may store information about the corresponding one of the user terminals 3420-1 to 3420-N. Here, the information about the user terminals 3420-1 to 3420-N may include terminal specification information.

In addition, the communication of each of the user terminals 3420-1 to 3420-N may perform functions of transmitting/receiving data to/from the virtual keyboard service provision apparatus 3410 or the cryptocurrency exchange 3430 over a network 3440. Here, the communication unit of each of the user terminals 3420-1 to 3420-N may include a Radio Frequency (RF) transmission means for up-converting the frequency of a signal to be transmitted and amplifying the frequency up-converted signal, and an RF reception means for low-noise amplifying a received signal and down-converting the frequency of the amplified signal. The communication unit of each of the user terminals 3420-1 to 3420-N may include a wireless communication module. In addition, the wireless communication module may be a component for transmitting/receiving data based on a wireless communication method. When each of the user terminals 3420-1 to 3420-N uses wireless communication, the wireless communication module may transmit/receive data to/from the cryptocurrency reward service provision apparatus 3410 or the cryptocurrency exchange 3430 using any one of a wireless network communication module, a wireless LAN (WLAN) communication module, and a Wireless Personal Area Network (PAN) communication module. That is, each of the user terminals 3420-1 to 3420-N may access the network 3440 using the wireless communication module, and may transmit/receive data to/from the virtual keyboard service provision apparatus 3410 or the cryptocurrency exchange 3430 over the network 3440. In particular, the network 3440 according to the present disclosure may transmit/receive data required for providing cryptocurrency rewards while communicating with the virtual keyboard service provision apparatus 3410, the cryptocurrency exchange 3430 or the user terminals 3420-1 to 3420-N.

Furthermore, the control unit of each of the user terminals 3420-1 to 3420-N may be a processing device for running an Operating System (OS) and individual components. For example, the control unit may control the overall process of accessing the virtual keyboard service provision apparatus 3410 or the cryptocurrency exchange 3430. When accessing the virtual keyboard service provision apparatus 3410 or the cryptocurrency exchange 3430 through the application, the control unit may control the overall process in which the application is executed in response to the request of the user, may control a service use request to be transmitted to the virtual keyboard service provision apparatus 3410 or to the cryptocurrency exchange 3430 at the same time that the application is executed, and may control information about the user terminal required for user authentication to be transmitted together with the service use request.

The cryptocurrency exchange 3430 may correspond to a server which converts or exchanges cryptocurrency with money (currency).

For example, cryptocurrency mined as the user uses the keyboard NFT-based virtual keyboard may be stored in the electronic wallet of each of the user terminals 3420-1 to 3420-N. The cryptocurrency stored in this way may be converted into another type of cryptocurrency or exchanged with normal money (currency) through the cryptocurrency exchange 3430.

The network 3440 provides a path through which data is transferred between virtual keyboard service provision apparatus 3410, the cryptocurrency exchange 3430, and the user terminals 3420-1 to 3420-N, and is a concept including both existing networks that have been conventionally used and networks that may be developed in the future. For example, such a network may be any one of a wired/wireless LAN for providing communication between various types of information devices in a limited area, a mobile communication network for providing communication between individual moving objects and between a moving object and an external system outside the moving object, a satellite communication network for providing communication between individual earth stations using satellites, and a wired/wireless communication network, or a combination of two or more thereof. Meanwhile, transfer mode standards for the network are not limited to existing transfer mode standards, but may include all transfer mode standards to be developed in the future.

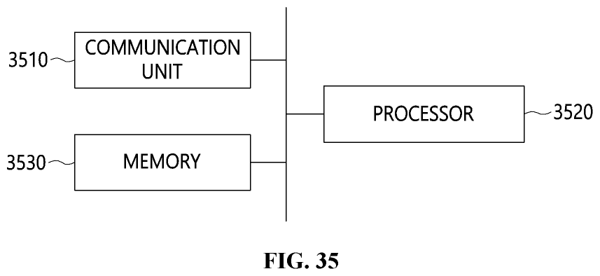

FIG. 35 is a block diagram illustrating an example of an apparatus for providing a virtual keyboard service of paying cryptocurrency rewards using a user wallet provided by a service provider according to an embodiment of the present disclosure.

Referring to FIG. 35, an apparatus for providing a virtual keyboard service of paying cryptocurrency rewards using a user wallet provided by a service provider according to the embodiment of the present disclosure may include a communication unit 3510, a processor 3520, and memory 3530.

The communication unit 3510 may function to transmit/receive information to provide a virtual keyboard service of paying cryptocurrency rewards using a user wallet provided by a service provider over a communication network such as a typical network. In particular, the communication unit 3510 according to the embodiment of the present disclosure may receive, in real time, data about cryptocurrency to be paid to a user from the virtual keyboard service provision apparatus or a cryptocurrency exchange.

The processor 3520 may create an on-chain user wallet and an off-chain-based virtual blockchain user wallet which match each other and lends the user wallets to a user who uses the virtual keyboard service.

In this case, an off-chain address at which the virtual blockchain user wallet is created may be identical to an on-chain address at which the on-chain user wallet is created.

Further, the processor 3520 may charge a lending fee for the on-chain user wallet and the virtual blockchain user wallet to the user at intervals of a preset period.

Furthermore, the processor 3520 may provide the virtual blockchain user wallet with cryptocurrency that is mined while the user uses the virtual keyboard service.

In this case, the cryptocurrency may correspond to a first token, which is a token usable in the virtual keyboard service, and the first token may be exchanged with a second token, which is a governance token that can be encashed in a cryptocurrency exchange.

Furthermore, the processor 3520 may provide an on-chain service to the user by linking the on-chain user wallet with the virtual blockchain user wallet at preset link timing.

In this case, the user may use the on-chain service using the virtual blockchain user wallet without requiring on-chain interaction.

Here, the user may access the virtual blockchain user wallet using both a public key provided from the service provider of the virtual keyboard service and a private key for user authentication, and may then use the on-chain service.

Here, the service provider may store public keys and private keys for respective users required for accessing the on-chain user wallets.

Here, the virtual keyboard service may access the application based on the keyboard NFT, may mine cryptocurrency in conformity with keyboard usage measured while the user utilizes a virtual keyboard, and may provide a reward corresponding to the mined cryptocurrency to the virtual blockchain user wallet of the user.

Here, the virtual keyboard service may mine cryptocurrency corresponding to the usage of each word corresponding to a word NFT purchased by the user, and may provide a reward corresponding to the cryptocurrency to the virtual blockchain user wallet of the user.

The memory 3530 may support a function of providing a virtual keyboard service of paying cryptocurrency rewards using a user wallet provided by a service provider according to the embodiment of the present disclosure, as described above. Here, the memory 3530 may function as separate large-capacity storage or may include a control function for performing operations.

Meanwhile, the virtual keyboard service provision apparatus may include memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, a storage device is a computer-readable medium. In various different embodiments, the storage device may include, for example, a hard-disk device, an optical disk device, or any other kind of mass storage device.

By means of the above-described apparatus for providing a virtual keyboard service of paying cryptocurrency rewards using a user wallet provided by a service provider, user convenience may be maximized by allowing a user who uses a virtual keyboard service to exploit a virtual blockchain user wallet in an off-chain without requiring on-chain interaction inconvenient to the user.

Further, the service provider of the virtual keyboard service may perform an on-chain service on a blockchain while minimizing unnecessary interaction with the user.

Furthermore, there can be provided a service for earning money through communication between users, such as Communication-to-Earn (C2E), thus inducing active communication between family members, friends, or acquaintances and providing benefits based on the active communication.

Further, related rewards may be provided to users who hold word NFTs by converting words, which are chiefly used when a virtual keyboard service is provided, into NFTs and providing the NFTs.

Furthermore, there can be provided a virtual keyboard service in which a blockchain technology is introduced into a virtual keyboard used by a user terminal, thus providing differentiated customer benefits and experiences compared to a conventional point provision-based virtual keyboard service.

Furthermore, the present disclosure may provide more variety of terminal virtual keyboards used by multiple users depending on the amount of usage without being limited to the simple use of the terminal virtual keyboard.

Furthermore, the structure of a virtual keyboard service for paying cryptocurrency rewards to be switchable to a point-accumulative virtual keyboard service may be designed, thus effectively securing multiple customers.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, a processing system.

A computer-readable medium can be a machine-readable storage device, a machine-readable storage substrate, a memory device, a composition of matter effecting a machine-readable propagated signal, or a combination of one or more of them.

The term ‘system’ or ‘apparatus’ encompasses all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Meanwhile, computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network.

While this specification contains many specific implementation details, these should not be construed as limitations on the scope of any disclosure or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Further, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

According to the present disclosure, an on-chain user wallet and an off-chain-based virtual blockchain user wallet which match each other may be created and lent to a user who uses a virtual keyboard service, cryptocurrency that is mined while the user uses the virtual keyboard service may be provided to the virtual blockchain user wallet, and an on-chain service may be provided to the user by linking the on-chain user wallet with the virtual blockchain user wallet at preset link timing. Furthermore, the present disclosure may provide more diverse benefits without being limited to simple usage of a keyboard, upon providing a keyboard service for terminals used by multiple users, thus inducing an amount of communication between family members, friends, and acquaintances to be increased, with the result that the use of the service can be effectively extended.

According to the present disclosure, user convenience may be maximized by allowing a user who uses a virtual keyboard service to exploit a virtual blockchain user wallet in an off-chain without requiring on-chain interaction inconvenient to the user.

Further, the present disclosure may provide convenience to users who use a virtual keyboard service by allowing a service provider to act as an intermediary in service tasks for securely storing and exchanging cryptocurrency assets of the users.

Furthermore, the present disclosure may provide a service for earning money through communication between users, such as Communication-to-Earn (C2E), thus inducing active communication between family members, friends, or acquaintances and providing benefits based on the active communication.

Furthermore, the present disclosure may provide related rewards to users who hold word NFTs by converting words, which are chiefly used when a virtual keyboard service is provided, into NFTs and providing the NFTs.

Furthermore, the present disclosure may provide a virtual keyboard service in which a blockchain technology is introduced to a virtual keyboard used by a user terminal, thus providing differentiated customer benefits and experiences compared to conventional point provision-based virtual keyboard service.

Furthermore, the present disclosure may provide more diverse benefits depending on the usage or usage amount of a virtual keyboard, without being limited to the service of simply utilizing a terminal-based virtual keyboard used by multiple users.

Furthermore, the present disclosure may design the structure of a virtual keyboard service for paying cryptocurrency rewards to be switchable to a point-accumulative virtual keyboard service, thus effectively securing multiple customers.

As described above, this specification is not intended to limit the present disclosure to the specific terms presented. Therefore, although the aforementioned examples have been provided to describe the present disclosure in detail, those skilled in the art may modify, change, and alter the examples without departing from the scope of the present disclosure. It is intended that the scope of the present disclosure should be defined by the accompanying claims rather than the above-described descriptions, and various modifications, additions and substitutions, which can be derived from the meaning, scope and equivalent concepts of the accompanying claims, fall within the scope of the present disclosure.

What is claimed is:

1. A method for providing a virtual keyboard service, comprising:
creating an on-chain user wallet and an off-chain-based virtual blockchain user wallet which match each other, and lending the created user wallets to a user who uses the virtual keyboard service;
providing cryptocurrency that is mined while the user uses the virtual keyboard service to the virtual blockchain user wallet; and
providing an on-chain service to the user by linking the on-chain user wallet with the virtual blockchain user wallet at preset link timing.

2. The method of claim 1, further comprising:
charging a lending fee for the on-chain user wallet and the virtual blockchain user wallet to the user at intervals of a preset period.

3. The method of claim 1, wherein an off-chain address at which the virtual blockchain user wallet is created is identical to an on-chain address at which the on-chain user wallet is created.

4. The method of claim 1, wherein the user uses the on-chain service based on the virtual blockchain user wallet without requiring on-chain interaction.

5. The method of claim 4, wherein the user accesses the virtual blockchain user wallet using both a public key provided from a service provider of the virtual keyboard service and a private key for user authentication, and then uses the on-chain service.

6. The method of claim 5, wherein the service provider stores pubic keys and private keys for respective users required for accessing corresponding on-chain user wallets.

7. The method of claim 1, wherein:
the cryptocurrency corresponds to a first token that is a keyboard token usable in the virtual keyboard service, and
the first token is exchangeable with a second token that is a governance token capable of being encashed in a cryptocurrency exchange.

8. The method of claim 7, wherein the virtual keyboard service is configured to mine cryptocurrency in conformity with keyboard usage that is measured while the user accesses an application based on a keyboard Non-Fungible Token (NFT) and uses a virtual keyboard, and to provide a reward corresponding to the mined cryptocurrency to the virtual blockchain user wallet of the user.

9. The method of claim 7, wherein the virtual keyboard service is configured to mine the cryptocurrency in conformity with usage of each word corresponding to a word NFT purchased by the user, and to provide a reward corresponding to the mined cryptocurrency to the virtual blockchain user wallet of the user.

10. An apparatus for providing a virtual keyboard service, comprising:
a processor configured to create an on-chain user wallet and an off-chain-based virtual blockchain user wallet which match each other, lend the created user wallets to a user who uses the virtual keyboard service, provide cryptocurrency that is mined while the user uses the virtual keyboard service to the virtual blockchain user wallet, and provide an on-chain service to the user by linking the on-chain user wallet with the virtual blockchain user wallet at preset link timing; and
a memory configured to store the on-chain user wallet and the virtual blockchain user wallet.
